(19) United States
(12) Patent Application Publication
(10) Pub. No.: US 2022/0167571 A1
(43) Pub. Date: Jun. 2, 2022

(54) Method for Avoiding High Temperature and Maintaining Yield of Rice

(71) Applicant: China National Rice Research Institute, Hangzhou (CN)

(72) Inventors: Yuping ZHANG, Hangzhou (CN); Yaliang WANG, Hangzhou (CN); Huizhe CHEN, Hangzhou (CN); Jing XIANG, Hangzhou (CN); Yikai ZHANG, Hangzhou (CN); Zhigang WANG, Hangzhou (CN)

(21) Appl. No.: 17/353,417

(22) Filed: Jun. 21, 2021

(30) Foreign Application Priority Data
Nov. 27, 2020 (CN) 202011367516.1

(51) Int. Cl. A01G 22/22; A01N 43/22; A01G 25/16; A01C 21/00

(52) U.S. Cl. CPC A01G 22/22; A01C 21/007; A01G 25/167; A01N 43/22

(57) ABSTRACT

The present disclosure relates to a method for avoiding high temperature and maintaining yield of rice. The method prevents high temperature and builds a comprehensive disaster prevention and mitigation system by screening high-temperature resistant varieties, sowing at suitable time, cultivating strong seedlings, irrigating, applying silicon fertilizer and adjusting density, and chemically regulating; the method can avoid or attenuate heat injury, and be conducive to maintaining yield in disasters. The present disclosure is appropriate for areas prone to high temperature in China, especially for rice regions in the middle and lower reaches of the Yangtze River and Southwest China, for example, Fuyang, Zhejiang Province, Lujiang, Anhui Province, Jingzhou, Hubei Province, and Luzhou, Sichuan Province.

### CROSS REFERENCE TO RELATED APPLICATION

This patent application claims the benefit and priority of Chinese Patent Application No. 202011367516.1, filed on Nov. 27, 2020, the disclosure of which is incorporated by reference herein in its entirety as part of the present application.

### TECHNICAL FIELD

The present disclosure relates to the technical field of rice planting, and in particular to a method for avoiding high temperature and maintaining yield of rice.

### BACKGROUND ART

In China, single cropping rice growing season is also a high temperature period of the year. The growth and developmental stage of rice is the highest temperature period of the year. The rise in temperature caused by global climate change will lead to heat injury of rice. Heat injury directly leads to decreased spikelet fertility rate, followed by the early maturity of rice at the grain filling stage of rice, and the decrease of thousand-grain weight; and the shortening of rice growth and developmental stage, and the decrease of biomass and yield.

In the past 50 years, there have been 6 major incidents of heat injury of rice in China. Among them, in 2003, the area of single cropping rice damaged by high temperature in the Yangtze River Basin was up to 10 million hectares, and some fields even had no harvest. Among main rice-producing areas in China, rice regions in the middle and lower reaches of the Yangtze River and Southwest China are the main rice regions where rice suffers from heat injury. In recent years, heat injury of rice has also appeared in the rice regions of South and North China. In the rice regions in the middle and lower reaches of the Yangtze River and Southwest China, single cropping rice is the most widely affected by heat injury and rice yield decreases most seriously. The flowering and filling period of continuously cropped early rice in the southern China is susceptible to high temperature.

When the rice suffers from the highest temperature of more than 38° C. for three consecutive days at the flowering stage, spikelets can be highly infertile, directly reducing the spikelet fertility rate. High temperature at the panicle differentiation stage of rice leads to wrapped leaf sheaths. The high temperature in the filling and ripening stage of rice leads to heat-forced maturity and decreased grain weight. Establishing a technology of avoiding high temperature and maintaining yield of rice is the basis for establishing a comprehensive disaster prevention and mitigation system and an effective measure to meet the requirements of food security in China.

### SUMMARY

To solve the above technical problems, a method for avoiding high temperature and maintaining yield of rice is provided.

The present disclosure is implemented by the following technical solutions:

A method for avoiding high temperature and maintaining yield of rice includes the following steps:

selecting varieties: selecting high-temperature resistant varieties for planting;

sowing at suitable time and cultivating strong seedlings: selecting a sowing and planting period according to the meteorological conditions, adjusting flowering stage, and avoiding high temperature at the booting and flowering stages;

applying silicon fertilizer and adjusting density: rationally applying a silicon fertilizer and adjusting planting density; and

spraying a plant growth regulator: starting spraying a plant growth regulator since the meiosis stage of rice pollen mother cells.

Preferably, the high-temperature resistant varieties may include Zhensizhan No. 1, Huasizhan, Huangsizhan, Huanghuazhan, and Shuyou 217.

Further, the sowing at suitable time may be specifically implemented by: using partial least squares regression analysis to construct functional relationships of spikelet differentiation and degeneration with growth and developmental stage, dry matter accumulation, meteorological conditions at the panicle differentiation stage, respectively, and selecting the sowing and planting period based on the spikelet fertility rate.

Further, independent variables of a partial least squares regression model may include: days of panicle differentiation, dry matter accumulation at the panicle differentiation stage, dry matter accumulation during panicle differentiation, average temperature during panicle differentiation, day and night temperature difference during panicle differentiation, and light radiation intensity during panicle differentiation.

Preferably, the plant growth regulator may include 2,4-epibrassinolide.

Further preferably, the 2,4-epibrassinolide may have a concentration of 0.55 mg/L.

Further, the plant growth regulator further may include glucose, fructose, and salicylic acid.

Preferably, application rate of the plant growth regulator may be 60-80 L/mu.

Further, irrigation for cooling may be performed at the high temperature sensitive heading and flowering stages, and the irrigation for cooling may be implemented by at least one of deep water irrigation in the field, daytime irrigation and night drainage, and running water irrigation.

Further, a rice ratooning method may be adopted for the rice damaged by extreme high temperature and summer drought.

Compared with the prior art, the present disclosure has the following beneficial effects:

The present disclosure simultaneously adopts high temperature prevention measures from seed selection, sowing, cultivation, and fertilization, and builds a comprehensive disaster prevention and mitigation system, avoiding or attenuating heat injury, and being conducive to maintaining yield in disasters.

### BRIEF DESCRIPTION OF THE DRAWINGS

The drawings described herein are intended to provide a further understanding of the examples of the present disclosure, constitute a part of the application, and do not constitute a limitation to the examples of the present disclosure.

FIG. 1 illustrates a relationship between spikelet fertility rate of main stem and accumulated damage temperature (>10° C.) at 10 days of heading;

FIG. 2(a) illustrates effects of silicon fertilizer application and different densities on Huanghuazhan yield and yield structure;

FIG. 2(b) illustrates effects of silicon fertilizer application and different densities on IR36 yield and yield structure;

FIG. 3 illustrates an effect of regulator treatment on spikelet degeneration at high temperature;

FIG. 4 illustrates an effect of regulator treatment on pollen viability at high temperature.

### DETAILED DESCRIPTION OF THE EMBODIMENTS

To make the objectives, technical solutions, and advantages of the present disclosure clearer, the present disclosure will be further described in detail below in conjunction with the examples and drawings. The exemplary examples and descriptions of the present disclosure are only intended to explain the present disclosure, not to limit the present disclosure.

The present disclosure provides a method for avoiding high temperature and maintaining yield of rice, including the following steps:

selecting varieties: selecting high-temperature resistant varieties for planting;

sowing at suitable time: selecting a sowing and planting period according to the meteorological conditions, adjusting flowering stage and avoiding high temperature during the booting and heading stages;

applying silicon fertilizer and adjusting density: rationally applying a silicon fertilizer and adjusting planting density, promoting population optimization and robust stalks, and increasing later drought tolerance and high temperature resistance; and

spraying a plant growth regulator: starting spraying a plant growth regulator since the meiosis stage of rice pollen mother cells, and attenuating an effect of heat injury.

Emergency measures should be taken in time to reduce losses at the high-temperature sensitive and flowering stage. The first is to irrigate the field with deep water to reduce panicle temperature. When the flowering stage of rice encounters high temperature seasons, the method of deep water irrigation and daytime irrigation and night drainage in rice fields may be used, or running water irrigation may be implemented to increase rice transpiration, lower rice canopy and leaf temperatures, and further lower temperature and increase humidity. The second is to rationally apply a silicon fertilizer based on fertilizer management, adjust reasonable planting density, promote population optimization and robust stalks, and increase later drought tolerance and high temperature resistance. The third is to spray 0.55 mg/L 2,4-epibrassinolide (EBR), and spray once every three days at the beginning of the meiosis stage of rice pollen mother cells for a total of three sprays. The EBR is sprayed until the leaves fall naturally, so that malondialdehyde content of anthers may significantly decrease, the content of soluble sugar and proline may increase, and the effect of heat injury may be attenuated.

A rice ratooning method may be adopted for the rice damaged by extreme high temperature and summer drought. High-temperature ratooning rice is about 20 days earlier than the ratooning rice ratooned after the harvest of middle-season rice in season. The low node seedlings will not be affected by low temperature, rain, and high temperature, which will reduce the spikelet fertility rate. When cutting seedlings, lower rice stubble (around 20-30 cm) may be reserved to promote the sprouting of axillary buds at the middle and low nodes of inverse 3^{rd} to 5^{th} leaves, effectively increase the number of ratooning rice seedlings, the number of panicles and the grain number, and be more conducive to maintaining yield in disasters.

On the condition that rice ratooning may fail due to high temperature and summer drought, machine-cut seedling cultivated land should be selected for this kind of rice field. After the high temperature and summer drought pass, fall crops, such as sweet potato, corn or various fall vegetables, may be replanted to make up for grain losses due to high temperature.

Based on the above method for avoiding high temperature and maintaining yield of rice, the present disclosure sets forth an example.

### Example 1

1. Variety Screening

In recent decades, with the advancement of genetic improvement technology of rice varieties in China, the types and quantities of rice varieties have increased. Although the environmental temperature for the breeding of rice varieties has gradually increased, and the resistance of the varieties to heat injury at the flowering and grain filling stages has increased, there is still a substantial difference in resistance to heat injury among the varieties. From 2017 to 2019, 159 different types of varieties in production were used; using a tailor-made artificial climate box, the rice varieties were treated at high temperature for 3 days at the flowering stage of rice. In accordance with the Identification and Classification of Heat Injury of Rice (NY/T 2915-2016) issued by the Ministry of Agriculture of the People's Republic of China, the artificial climate box was set with two temperature gradients, and the humidity was controlled at 70-80% (Table 6). The screening results showed that five heat-resistant varieties were selected (N22 control), including Zhensizhan No. 1, Huasizhan, Huangsizhan, Huanghuazhan, and Shuyou 217. These five varieties had wide adaptability. Compared with other varieties, at high temperature, the range of yield reduction was small or there was no yield reduction, and the yield was high in the absence of high temperature. Herein, Huanghuazhan and Zhensizhan No. 1 were identified as heat-resistant varieties for three consecutive years.

2. Sowing at Suitable Time and Cultivating Strong Seedlings

The sowing time of single cropping rice in the middle and lower reaches of the Yangtze River is generally from late April to mid-May, and that in the rice region of southwest China is earlier, from late March to mid-April. According to the meteorological data over the years or the forecasted meteorological conditions of the year, farmers select an appropriate sowing and planting period, adjust the flowering stage, and avoid the high temperature at booting and heading stages. Dry nursery seedlings are used to cultivate strong seedlings; medium and late high-temperature resistant varieties can be selected as middle-season rice; the sowing time is properly delayed so that the flowering stage of indica rice is in late August and the flowering stage of japonica rice is ended from late August to early September. This may avoid or attenuate heat injury in summer.

Based on the analysis of the sensitivity of different photoperiods, this example conducts a yield analysis of interval sowing, and provides a reference for the selection of single cropping rice varieties that avoid the delay of high temperature sowing time in the middle and lower reaches of the Yangtze River and the control of heat damage.

There were eight tested varieties: Zhongzheyou No. 1 (V1), Tianyou Huazhan (V2), Yongyou 538 (V3), Chunyou 927 (V4), Chujing 27 (V5), Xiushui 134 (V6), Huanghuazhan (V7), and Xiangwanxian 13 (V8).

The experimental treatment included 10 sowing dates, namely April 10 (51), April 20 (S2), April 30 (S3), May 10 (S4), May 20 (S5), May 30 (S6), June 9 (S7), June 19 (S8), June 29 (S9), and July 9 (S10); the seedling age was 20 days. Suitable sowing studies were carried out for three consecutive years.

The meteorological factors, environmental factors and yield of the interval sowing were analyzed to clarify relationships among the factors and provide a basis for selecting appropriate sowing time to avoid disasters. Correlation analysis showed that the grain number per panicle and the spikelet fertility rate at different sowing time were the most critical factors affecting the yield, among which the spikelet fertility rate was mainly related to the meteorological conditions at the heading stage; at different sowing time, the grain number per panicle was a decisive factor for yield formation. Through the monitoring of rice field meteorological factors and the comparison of historical meteorological data, a relationship between accumulated damage temperature and spikelet fertility rate was established to measure the impact of temperature stress on seed setting, and to provide a reference for the selection of varieties and sowing time.

Herein, the calculation method of the accumulated damage temperature is:

Accumulated damage temperature 10 days after designated heading (° C.)=Actual accumulated temperature 10 days after heading at designated sowing time−Optimal accumulated temperature 10 days after heading.

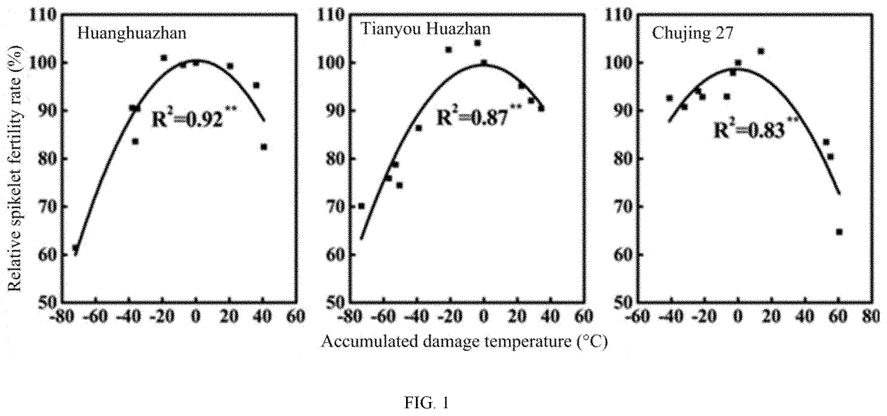

As shown in FIG. 1, it can be seen that the relative spikelet fertility rate of Huanghuazhan and Tianyou Huazhan increases as the decrease range of increase in negative accumulated temperature is greater than that of increase in positive accumulated temperature, indicating that low temperature has a greater effect on Huang Huazhan and Tianyou Huazhan than positive accumulated temperature However, in Chujing 27, the increase in positive accumulated temperature and the decrease in spikelet fertility rate are greater than that of the negative accumulated temperature, indicating that high temperature has a greater effect on Chujing 27 than low temperature.

Herein, the relationship between accumulated damage temperature and relative spikelet fertility rate of Huanghuazhan respectively conforms to formula (1);

Y=−0.0076X²+0.0078X+100 (1)

The relationship between accumulated damage temperature and relative spikelet fertility rate of Tianyou Huazhan respectively conforms to formula (2);

Y=−0.0068X²+0.0076X+100 (2)

The relationship between accumulated damage temperature and relative spikelet fertility rate of Chujing 27 respectively conforms to formula (3);

Y=−0.0075X²−0.0072X+100 (3)

Partial least squares regression analysis was used to construct functional relationships of spikelet differentiation and degeneration at different sowing time with growth and developmental stage, dry matter accumulation, meteorological conditions at the panicle differentiation stage; combined with the prediction of the spikelet fertility rate, a theoretical basis was provided for the selection of sowing time to avoid high temperature, as shown in Tables 1 and 2.

The present example further used partial least squares regression analysis to construct functional relationships of spikelet differentiation and degeneration at different sowing time with growth and developmental stage, dry matter accumulation, meteorological conditions at the panicle differentiation stage; combined with the prediction of the spikelet fertility rate, a theoretical basis was provided for the selection of sowing time to avoid high temperature, as shown in Tables 1 and 2.

TABLE 1
Differentiated spikelet number model by partial least squares regression analysis

| Variety | Model | R² |
|---|---|---|
| Yongyou 538 | Y = 4.2X₁ − 48.1X₂ − 61.8X₃ + 28.4X₄ + 48X₅ − 4.9X₆ + 705.6 | 0.89** |
| Chunyou 927 | Y = −3.8X₁ + 12.1X₂ − 18.1X₃ + 8.8X₄ − 20.7X₅ + 8.9X₆ + 294.9 | 0.82** |
| Huanghuazhan | Y = 0.23X₁ + 15.4X₂ + 49.7X₃ + 0.28X₄ + 5.83X₅ − 2.1X₆ + 127.4 | 0.69** |
| Yongyou 538 | Y = −2.6X₁ − 8.7X₂ + 3.1X₃ + 20.4X₄ − 5.5X₅ + 59.7X₆ − 651.3 | 0.89** |
| Chujing 27 | Y = −21.1X₁ − 31.6X₂ − 46.5X₃ + 38.3X₄ + 10.6X₅ − 33.6X₆ + 193.5 | 0.65** |
| Huanghuazhan | Y = −6.4X₁ − 167.3X₂ + 153.4X₃ + 40.1X_{4 -} _{6.6X5} − 40.2X₆ − 296.2 | 0.85** |
| Xiushui 134 | Y = −1.8X₁ + 25.2X₂ + 4.7X₃ + 25.6X₄+23.0X₅ − 30.3X₆ + 20.7 | 0.92** |

In Table 1, Y is differentiated spikelet number; X1 is days of panicle differentiation; X2 is dry matter accumulation at the panicle differentiation stage; X3 is dry matter accumulation during panicle differentiation; X4 is average temperature during panicle differentiation; X5 is day and night temperature difference during panicle differentiation; X6 is light radiation intensity during panicle differentiation.

TABLE 2
Spikelet degeneration rate model by partial least squares regression analysis

| Variety | Model | R² |
|---|---|---|
| Yongyou 538 | Y = 1.3X₁ + 4.0X₂ + 3.0X₃ − 2.0X₄ + 0.5X₅ − 1.3X₆ − 23.4 | 0.90** |
| Chunyou 927 | Y = −1.7X₁ + 11.8X₂ + 11.8X₃ − 67.7X₄ + 1.1X₄² + 246.5X₅ − 9.3X₅² − 13.8X₆ − 0.7X₆² − 481.9 | 0.90** |
| Huanghuazhan | Y = 2.0X₁ − 12.9X₂ − 7.8X₃ − 36.6X₄ + 0.53X₄² + 37.2X₅ − 1.1X₅² − 28.1X₆ + 1.4X₆² + 451.1 | 1.00** |
| Yongyou 538 | 538Y =0.03X1 - 1.5X2- 1.3X3 +5.5X4- 7.9X5 +8.8X6- 148.5 | 0.92** |
| Chujing 27 | Y = −3.0X₁ − 3.9X₂ − 1.0X₃ − 3.1X₄ +0.2X₄² − 20.2X₅ + 0.3X₅² − 13.3X₆ + 0.7X₆² + 331.1 | 0.91** |
| Huanghuazhan | Y = −5.5X₁ − 64.3X₂ + 42.3X₃ + 11.8X₄ − 5.3X₄² − 99.2X₅ + 3.8X₅² + 21.2X₆ − 1.5X₆² + 509.1 | 0.98** |
| Xiushui 134 | Y = −3.0X₁ + 5.1X₂ + 7.9X₃ − 0.3X₄ + 8.7X₅ - 5.6X₆ − 35.2 | 0.99** |

In Table 2, Y is differentiated spikelet number; X1 is days of panicle differentiation; X2 is dry matter accumulation at the panicle differentiation stage; X3 is dry matter accumulation during panicle differentiation; X4 is average temperature during panicle differentiation; X5 is day and night temperature difference during panicle differentiation; X6 is light radiation intensity during panicle differentiation.

3. Increasing Silicon Fertilizer and Adjusting Density, and Reducing Disasters to Maintain Yield

Rationally apply a silicon fertilizer based on fertilizer management, adjust reasonable planting density, promote population optimization and robust stalks, and increase later drought tolerance and high temperature resistance. Silicon fertilizer application can increase rice grain number per panicle, thereby increasing yield; by increasing the density, effective panicle number of rice can be increased, thereby increasing the yield. Moreover, application of silicon fertilizer to basal fertilizer can promote good pollen development and reduce the appearance of pollen developmental malformation; to a certain extent, the number of stem sheath vascular bundles can be increased, the accumulation of sugar in the pollen and the rice grain number per panicle can be improved, and yield loss at high temperature can be reduced.

The amount of basal fertilizer is 4-6 kg of silica per mu.

To verify the effect of silicon fertilizer increasing and density adjusting measures, a comparative experiment was done in this example, which was specifically as follows:

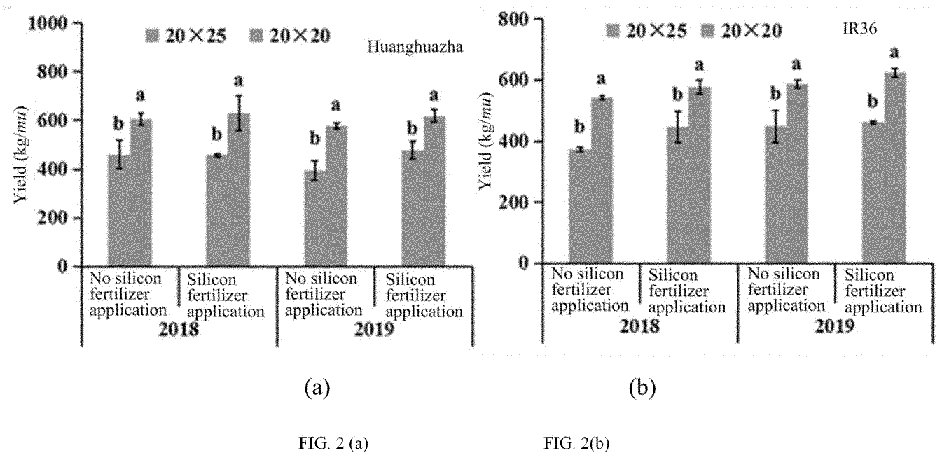

The test materials were included high-temperature resistant variety Huanghuazhan and heat-sensitive variety IR36; both varieties were applied with and without silicon fertilizer, and two planting specifications, 20×25 cm and 20×20 cm, were set up. The yield results are shown in FIG. 2(a) and FIG. 2(b). The results showed that both applying silicon fertilizer and increasing planting density could increase the yield. On average, applying silicon fertilizer increased Huanghuazhan yield by 7.1%, and IR36 yield by 8.1%, especially in the 20×25 cm planting specification. On average, increasing density increased Huanghuazhan yield by 35.7%, and IR36 yield by 34.7%.

4. Chemical Regulation

The main components of the plant growth regulator used in this example included: 2,4-epibrassinolide (EBR), glucose, fructose, and a certain concentration of salicylic acid.

Application per mu: 2,4-epibrassinolide (EBR) 25 mg, salicylic acid 300 mg, glucose 400 mg, fructose 400 mg, potassium dihydrogen phosphate 1 g, and Tween (surfactant) 20 mg.

The optimum concentration of 2,4-epibrassinolide was 0.55 mg/L. The application rate of the plant growth regulator was 60-80 L/mu. 2,4-Epibrassinolide promotes the utilization of carbohydrates and material transport during rice panicle development by promoting glycolysis, metabolism of related hormones, and tricarboxylic acid cycle. Salicylic acid can improve plant antioxidant capacity at high temperatures. Combined use of glucose and fructose is to provide sufficient carbohydrate supply and material source for the development of young rice panicle.

To verify the effect of the plant growth regulator measure, a comparative experiment was done in this example, which was specifically as follows:

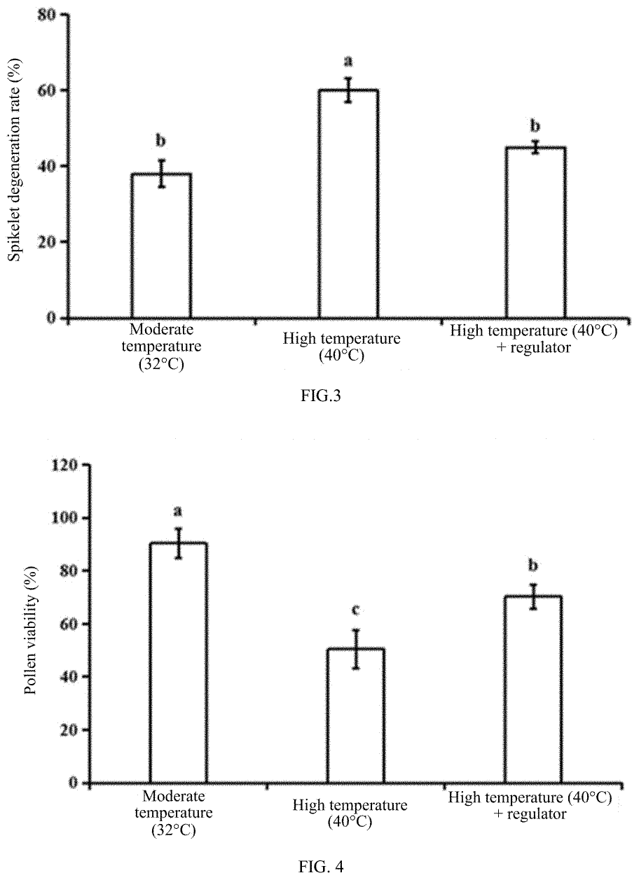

An artificial climate box was used to simulate rice with inverse 2^{nd} to 1^{st} leaves at 40° C. for 15 days; the 40° C. high temperature treatment time was from 9:00 a.m. to 17:00 p.m., and the 32° C. moderate temperature treatment at the same time interval was used as a control. The plant growth regulator prepared in Example 1 was sprayed when the core leaves of the inverse 2^{nd} and 1^{st} leaves were half-grown. The results are shown in Table 3, FIGS. 3 and 4.

TABLE 3
Yield results after regulator application at high temperature

| | Number | Grain | | | |
|---|---|---|---|---|---|
| | of | number | Spikelet | 1000- | Yield |
| | panicles | per | fertility | grain | per |
| | per plant | panicle | rate | weight | plant |
| Treatment | (panicle) | (grain) | (%) | (g) | (g) |
| Moderate | 12.1a | 100.7a | 81.4a | 19.6a | 19.1a |
| temperature | | | | | |
| (32° C.) | | | | | |
| High temperature | 12.3a | 52.5c | 46.6c | 18.0b | 5.4c |
| (40° C.) | | | | | |
| High temperature | 12.2a | 89.3b | 70.6b | 18.3b | 14.1b |
| (40° C.) + | | | | | |
| plant growth | | | | | |
| regulator | | | | | |

NOTE:
Different letters in each column of data indicate significant differences at a 5% level.

The results showed that the grain number per panicle decreased by 47.9% at a high temperature of 40° C. compared with that at the control moderate temperature of 32° C.; while spraying the plant growth regulator at high temperature, the grain number per panicle increased by 70.1% compared with that at high temperature, and decreased by 11.3% at 32° C. It was indicated that the damage of high temperature to the formation of panicles and grains was alleviated by spraying the regulator to reduce the spikelet degeneration rate, while the spraying of the regulator improved the spikelet fertility rate by increasing the pollen viability at high temperature. The spraying of the regulator at high temperature increased the grain number per panicle and the spikelet fertility rate and reduced the yield loss by 44.9% relative to that at the moderate temperature of 32° C.

This example further performed a statistical analysis on the application costs of the main components of mitigants with different costs, and found that 2,4-epibrassinolide had a lower application cost; when combined with salicylic acid, glucose, and fructose, the cost price per mu was at around RMB 120, which was the lowest among all high-temperature regulators, as shown in Table 4.

TABLE 4
Cost analysis of different high temperature mitigants

| | | |
|---|---|---|
| Application | Application | |
| concen- | per | Cost per |

| Product | tration | | mu | | Unit price | | | | mu |
|---|---|---|---|---|---|---|---|---|---|
| 2,4- | 0.55 | mg/L | 9 | mg | RMB | 700/100 | mg | (Solarbio) | RMB |
| Epibrassi- | | | | | | | | | 63 |
| nolide | 100 | μmol/L | 4 | mmol | RMB | 1,216/50 | mg | (Sigma- | RMB |
| Salicylic | | | | (552 | | | | Aldrich) | 13,424 |
| acid | | | | mg) | | | | | |
| Naphthyl- | 50 | mg/L | 2 | g | RMB | 300/50 | mg | (Solarbio) | RMB |
| acetic acid | | | | | | | | | 12,000 |
| Indoleacetic | 20 | mg/L | 0.8 | g | RMB | 493/250 | mg | (Sigma- | RMB |
| acid | | | | | | | | Aldrich) | 1,577.6 |
| Gibberellin | 30 | mg/L | 1.2 | g | RMB | 1,205/1 | g | (Sigma) | RMB |
| | | | | | | | | | 1,446 |
| Cytokinin | 10 | mg/L | 0.4 | g | RMB | 568/100 | mg | (Phyto- | RMB |
| | | | | | | | | tech) | 2,272 |

The yield loss can be reduced by more than 8.1% by adopting the method for avoiding high temperature and maintaining yield of rice provided by the present disclosure compared with the control. The present disclosure is appropriate for areas prone to high temperature in China, especially for rice regions in the middle and lower reaches of the Yangtze River and Southwest China, for example, Fuyang, Zhejiang Province, Lujiang, Anhui Province, Jingzhou, Hubei Province, and Luzhou, Sichuan Province.

Climate warming has caused China's rice-planting belt to move northward, and the northward movement of rice-growing areas has encountered water constraints. Rising temperature shortens the growth and developmental stage of rice and increases the probability of encountering high temperatures at the flowering stage of rice; meanwhile, rising temperatures lead to frequent outbreak of rice diseases and insect pests. In the implementation of a high temperature avoidance and disaster mitigation technology of rice, comprehensive control of diseases and insect pests should be paid attention to.

The objectives, technical solutions, and beneficial effects of the present disclosure are further described in detail in the foregoing specific implementations. It should be understood that the foregoing descriptions are merely specific implementations of the present disclosure, but are not intended to limit the protection scope of the present disclosure. Any modification, equivalent replacement, or improvement made within the spirit and principle of the present disclosure shall fall within the protection scope of the present disclosure.

What is claimed is:

1. A method for avoiding high temperature and maintaining yield of rice, comprising the following steps:
selecting varieties: selecting high-temperature resistant varieties for planting;
sowing at suitable time and cultivating strong seedlings: selecting a sowing and planting period according to the meteorological conditions, adjusting flowering stage, and avoiding high temperature at the booting and flowering stages;
applying silicon fertilizer and adjusting density: rationally applying a silicon fertilizer and adjusting planting density; and
spraying a plant growth regulator: starting spraying a plant growth regulator since the meiosis stage of rice pollen mother cells.

2. The method for avoiding high temperature and maintaining yield of rice according to claim 1, wherein the high-temperature resistant varieties comprise Zhensizhan No. 1, Huasizhan, Huangsizhan, Huanghuazhan, and Shuyou 217.

3. The method for avoiding high temperature and maintaining yield for rice according to claim 1, wherein the sowing at suitable time is specifically implemented by: using partial least squares regression analysis to construct functional relationships of spikelet differentiation and degeneration with growth and developmental stage, dry matter accumulation, meteorological conditions at the panicle differentiation stage, respectively, and selecting the sowing and planting period based on the spikelet fertility rate.

4. The method for avoiding high temperature and maintaining yield of rice according to claim 3, wherein independent variables of a partial least squares regression model comprise: days of panicle differentiation, dry matter accumulation at the panicle differentiation stage, dry matter accumulation during panicle differentiation, average temperature during panicle differentiation, day and night temperature difference during panicle differentiation, and light radiation intensity during panicle differentiation.

5. The method for avoiding high temperature and maintaining yield of rice according to claim 1, wherein the plant growth regulator comprises 2,4-epibrassinolide.

6. The method for avoiding high temperature and maintaining yield of rice according to claim 5, wherein the 2,4-epibrassinolide has a concentration of 0.55 mg/L.

7. The method for avoiding high temperature and maintaining yield of rice according to claim 5, wherein the plant growth regulator further comprises glucose, fructose, and salicylic acid.

8. The method for avoiding high temperature and maintaining yield of rice according to claim 1, wherein application rate of the plant growth regulator is 60-80 L/mu.

9. The method for avoiding high temperature and maintaining yield of rice according to claim 5, wherein application rate of the plant growth regulator is 60-80 L/mu.

10. The method for avoiding high temperature and maintaining yield of rice according to claim 6, wherein application rate of the plant growth regulator is 60-80 L/mu.

11. The method for avoiding high temperature and maintaining yield of rice according to claim 1, wherein irrigation for cooling is performed at the high temperature sensitive heading and flowering stages, and the irrigation for cooling is implemented by at least one of deep water irrigation in the field, daytime irrigation and night drainage, and running water irrigation.

12. The method for avoiding high temperature and maintaining yield of rice according to claim 1, wherein a rice ratooning method is adopted for the rice damaged by extreme high temperature and summer drought.
